(19) United States
(12) Patent Application Publication
(10) Pub. No.: US 2022/0340733 A1
(43) Pub. Date: Oct. 27, 2022

(54) ORGANOSILICON COMPOUND, MIXTURE OF ORGANOSILICON COMPOUND AND METHOD FOR PRODUCING SAME, RUBBER COMPOSITION CONTAINING MIXTURE OF ORGANOSILICON COMPOUND, AND TIRE

(71) Applicant: SHIN-ETSU CHEMICAL CO., LTD., Tokyo (JP)

(72) Inventors: Munenao HIROKAMI, Annaka-shi (JP); Shigeki YASUDA, Annaka-shi (JP); Yoshinori YONEDA, Tokyo (JP)

(73) Assignee: SHIN-ETSU CHEMICAL CO., LTD., Tokyo (JP)

(21) Appl. No.: 17/761,066

(22) PCT Filed: Aug. 3, 2020
(86) PCT No.: PCT/JP2020/029627

§ 371 Date: Mar. 16, 2022

(30) Foreign Application Priority Data
Sep. 17, 2019 (JP) 2019-168622

(51) Int. Cl. C08K 5/548; C07F 7/18; C08L 9/06; B60C 1/00

(52) U.S. Cl. CPC C08K 5/548; C07F 7/1804; C08L 9/06; B60C 1/0016

(57) ABSTRACT

A mixture of an organosilicon compound represented by average structural formula (2), wherein the area percentage occupied by an organic compound represented by structural formula (1) in GPC is from 5% to 95%, provides a rubber composition which exhibits excellent dispersibility of an inorganic filler and enables the achievement of a crosslinked cured product that has improved wear resistance, rolling resistance and wet grip performance. This rubber composition enables the achievement of a desired low fuel consumption tire.

(R¹O)₃₋ₚ(R²O)ₚSi—(CH₂)ⱼ—S_{y}—(CH₂)ₖ—Si(OR²)_{q}(OR)_{3-q} (2):

(In the formula, R¹ represents an alkyl group having from 1 to 3 carbon atoms; R² represents an alkyl group having from 4 to 8 carbon atoms; p represents a number from 0 to 3; q represents a number from 0 to 3; j represents a number from 1 to 10; k represents a number from 1 to 10; and y represents a number from 2 to 8.)

(R¹O)₃₋ₘ(R²O)ₘSi—(CH₂)ₕ—Sₓ—(CH₂)ᵢ—Si(OR²)ₙ(OR₁)₃₋ₙ (1):

(In the formula, R¹ and R² are as defined above; m represents an integer from 0 to 3; n represents an integer from 0 to 3; h represents an integer from 1 to 10; i represents an integer from 1 to 10; x represents an integer from 2 to 8; and (m+n) represents an integer from 3 to 6.)

### TECHNICAL FIELD

This invention relates to an organosilicon compound, a mixture of organosilicon compounds, a method of preparing the mixture, a rubber composition comprising the mixture of organosilicon compounds, and a tire.

### BACKGROUND ART

Silica-filled tires show excellent performance in the automotive application, especially excellent wear resistance, rolling resistance, and wet grip. Since these performance improvements are closely related to a saving of fuel consumption of tires, active efforts are currently devoted thereto.

The silica-filled rubber compositions are effective for reducing rolling resistance and improving wet grip of tires, but have a high unvulcanized viscosity and require multi-stage milling, giving rise to a problem in terms of working.

Therefore, rubber compositions simply loaded with inorganic fillers like silica suffer from problems like poor dispersion of the filler and substantial drops of rupture strength and wear resistance. Sulfur-containing organosilicon compounds are thus used for the purposes of improving the dispersion of the inorganic filler in the rubber and for establishing chemical bonds between the filler and the rubber matrix.

As the sulfur-containing organosilicon compound, compounds containing an alkoxysilyl group and polysulfidesilyl group in the molecule, for example, bis(triethoxysilylpropyl)tetrasulfide and bis(triethoxysilylpropyl)disulfide are known effective (see Patent Documents 1 to 4). Further improvements in silica dispersion and tire physical properties such as wear resistance, rolling resistance, and wet grip are desired.

As the compound containing an alkoxysilyl group and polysulfidesilyl group in the molecule, bis(triethoxysilylpropyl)polysulfide compounds in which some silicon-bonded alkoxy groups are substituted by octyloxy groups are also known (Patent Document 5).

### PRIOR ART DOCUMENTS

### Patent Documents

Patent Document 1: JP-A 2004-525230

Patent Document 2: JP-A 2004-018511

Patent Document 3: JP-A 2002-145890

Patent Document 4: JP-A 2000-103795

Patent Document 5: JP-A 2005-510520

### SUMMARY OF INVENTION

### Technical Problem

An object of the invention, which has been made under the above-mentioned circumstances, is to provide a mixture of organosilicon compounds suitable for use in a rubber composition which is improved in dispersion of inorganic fillers such as silica, and wear resistance, rolling resistance, and wet grip of its crosslinked cured product so that desired low fuel consumption tires may be manufactured.

### Solution to Problem

Making extensive investigations to solve the outstanding problems, the inventors have found that a rubber composition comprising a mixture of organosilicon compounds of specific structure in a specific mix ratio is good in dispersion of inorganic fillers such as silica and cures into a cured product having improved wear resistance, rolling resistance, and wet grip, so that tires having desired low fuel consumption properties can be manufactured therefrom. The invention is predicated on this finding.

Accordingly, the invention provides the following.

1. An organosilicon compound having the structural formula (1):

(R¹O)₃₋ₘ(R²O)ₘSi—(CH₂)ₕ—Sₓ—(CH₂)ᵢ—Si(OR²)ₙ(OR¹)₃₋ₙ (1)

wherein R¹ is each independently a C₁-C₃ alkyl group, R² is each independently a C₄-C₈ alkyl group, m is an integer of 0 to 3, n is an integer of 0 to 3, h is an integer of 1 to 10, i is an integer of 1 to 10, x is an integer of 2 to 8, and m+n is an integer of 3 to 6.
2. A mixture of organosilicon compounds comprising the organosilicon compound of 1, the organosilicon compounds having the average structural formula (2), wherein on analysis by gel permeation chromatography, the area percent of the organosilicon compound having formula (1) is 5 to 95% based on the overall mixture,

(R¹O)₃₋ₚ(R²O)ₚSi—(CH₂)ⱼ—S_{y}—(CH₂)ₖ—Si(OR²)_{q}(OR¹)_{3-q} (2)

wherein R¹ is each independently a C₁-C₃ alkyl group, R² is each independently a C₄-C₈ alkyl group, p is a number of 0 to 3, q is a number of 0 to 3, j is a number of 1 to 10, k is a number of 1 to 10, y is a number of 2 to 8, and p+q is a number of 0.15 to 6.
3. A method of preparing a mixture of organosilicon compounds comprising the step of reacting at least one organosilicon compound having the structural formula (3):

(R¹O)₃Si—(CH₂)ₕ—Sₓ—(CH₂)ᵢ—Si(OR¹)₃ (3)

wherein R¹ is each independently a C₁-C₃ alkyl group, h is an integer of 1 to 10, i is an integer of 1 to 10, and x is an integer of 2 to 8, with at least one alcohol having the structural formula (4):

R²OH (4)

wherein R² is a C₄-C₈ alkyl group in the presence of a catalyst,

the mixture consisting of organosilicon compounds having the average structural formula (2):

(R¹O)₃₋ₚ(R²O)ₚSi—(CH₂)ⱼ—S_{y}—(CH₂)ₖ—Si(OR²)_{q}(OR¹)_{3-q} (2)

wherein R¹ and R² are as defined above, p is a number of 0 to 3, q is a number of 0 to 3, j is a number of 1 to 10, k is a number of 1 to 10, y is a number of 2 to 8, and p+q is a number of 0.15 to 6.
4. The method of 3 wherein the catalyst is methanesulfonic acid.
5. A rubber composition comprising the mixture of organosilicon compounds of 2.
6. A tire obtained by molding the rubber composition of 5.
7. A cured product of the rubber composition of 5.
8. A tire comprising the cured product of 7.

### Advantageous Effects of Invention

The rubber composition comprising the mixture of organosilicon compounds according to the invention is good in dispersion of inorganic fillers such as silica. Tires manufactured from the composition have improved wear resistance, rolling resistance, and wet grip and meet the desired low fuel consumption tire properties.

### DESCRIPTION OF EMBODIMENTS

Now the invention is described in detail.

### [1] Organosilicon Compound and Mixture of Organosilicon Compounds

The invention provides an organosilicon compound having the structural formula (1).

(R¹O)₃₋ₘ(R²O)ₘSi—(CH₂)ₕ—Sₓ—(CH₂)ᵢ—Si(OR²)ₙ(OR¹)₃₋ₙ (1)

In formula (1), R¹ is each independently an alkyl group of 1 to 3 carbon atoms, and R² is each independently an alkyl group of 4 to 8 carbon atoms.

The C₁-C₃ alkyl group R¹ may be straight, branched or cyclic and examples thereof include methyl, ethyl, n-propyl and i-propyl, with ethyl being preferred.

The C₄-C₈ alkyl group R² may be straight, branched or cyclic and examples thereof include n-butyl, s-butyl, t-butyl, n-pentyl, n-hexyl, n-heptyl, and n-octyl. Of these, n-hexyl, n-heptyl and n-octyl are preferred for a tire composition-improving effect.

The subscripts h and i are each independently an integer of 1 to 10, with h=i=3 being preferred for availability of reactants.

The subscript m is an integer of 0 to 3, n is an integer of 0 to 3, and m+n is an integer of 3 to 6, preferably 3 to 5, more preferably 3 or 4.

The subscript x is an integer of 2 to 8, preferably 2 to 6, more preferably 2 to 4.

The invention also provides a mixture of organosilicon compounds having the average structural formula (2).

(R¹O)₃₋ₚ(R²O)ₚSi—(CH₂)ⱼ—S_{y}—(CH₂)ₖ—Si(OR²)_{q}(OR¹)_{3-q} (2)

In formula (2), R¹ and R² have the same meaning as in formula (1), and their suitable and preferred examples are as exemplified above in formula (1).

The subscript p is a number of 0 to 3, and q is a number of 0 to 3. The sum of p+q is in a range of 0.15 to 6.0, preferably 0.5 to 5.0, more preferably 1.5 to 4.0. The range of p+q ensures a satisfactory effect of improving rubber physical properties of a tire composition.

The subscript j is a number of 1 to 10, k is a number of 1 to 10, and both j and k are preferably 3.

The subscript y is a number of 2 to 8, preferably an integer of 2 to 6, more preferably an integer of 2 to 4.

The mixture of organosilicon compounds is, as viewed from the aspect of enhancing the effect of improving rubber physical properties of a tire-forming rubber composition containing the mixture, such that the area percent of a peak assigned to the organosilicon compound having structural formula (1) as analyzed by gel permeation chromatography (GPC) is 5 to 95%, preferably 8 to 70% based on the overall mixture having average structural formula (2).

The mixture of organosilicon compounds can be prepared by reacting at least one organosilicon compound having the structural formula (3) with at least one alcohol having the structural formula (4) in the presence of a catalyst.

(R¹O)₃Si—(CH₂)ₕ—Sₓ—(CH₂)ᵢ—Si(OR¹)₃ (3)

R²OH (4)

Herein R¹, R², h, i and x are as defined above.

Examples of the organosilicon compound having structural formula (3) include bis(triethoxysilylpropyl)tetrasulfide, bis(triethoxysilylpropyl)disulfide, bis(triethoxysilylhexyl)tetrasulfide, bis(triethoxysilylhexyl)disulfide, bis(triethoxysilyloctyl)tetrasulfide, and bis(triethoxysilyloctyl)disulfide. Inter alia, bis(triethoxysilylpropyl)tetrasulfide and bis(triethoxysilylpropyl)disulfide are preferred for availability of reactants.

Examples of the alcohol having structural formula (4) include n-butanol, n-hexanol and n-octanol.

As the catalyst, any suitable one may be selected from well-known catalysts used in transesterification reaction. However, when organic tin-based polymerization catalysts, organic titanium-based catalysts, and organic aluminum-based catalysts are used, the resulting organosilicon compound mixture is insufficient in storage stability.

When the stability of an organosilicon compound mixture is taken into account, organic strong acidic catalysts such as methanesulfonic acid and dodecylbenzenesulfonic acid are preferred. Methanesulfonic acid is most preferred in that the resulting organosilicon compounds become more transparent.

For the reaction, an organic solvent may be used if necessary.

Exemplary organic solvents include aliphatic hydrocarbon solvents such as pentane, hexane, heptane and decane; ether solvents such as diethyl ether, tetrahydrofuran and 1,4-dioxane; amide solvents such as formamide, dimethylformamide and N-methylpyrrolidone; aromatic hydrocarbon solvents such as benzene, toluene and xylene; and alcohol solvents such as methanol, ethanol and propanol.

The reaction temperature is typically 20 to 120° C., preferably 60 to 90° C.

The reaction time, which is not particularly limited, is typically about 1 to about 24 hours, preferably 1 to 12 hours, more preferably 1 to 10 hours.

### [2] Rubber Composition

The invention further provides a rubber composition comprising the mixture of organosilicon compounds having average structural formula (2), typically comprising (A) the mixture of organosilicon compounds having average structural formula (2), (B) a diene rubber, and (C) a filler.

In the rubber composition, the amount of component (A) or organosilicon compound mixture blended is preferably 0.1 to 20 parts by weight, more preferably 1 to 10 parts by weight per 100 parts by weight of the filler (C) when physical properties of the resulting rubber and a balance between the extent of the developed effect and economy are taken into account.

As component (B) or diene rubber, any of rubbers commonly used in conventional rubber compositions may be used. Examples include natural rubber (NR), and diene rubbers such as various isoprene rubbers (IR), various styrene-butadiene copolymer rubbers (SBR), various polybutadiene rubbers (BR), and acrylonitrile-butadiene copolymer rubbers (NBR), which may be used alone or in admixture. Besides the diene rubber, non-diene rubbers such as butyl rubber (IIR) and ethylene-propylene copolymer rubbers (EPR, EPDM) may be additionally used.

Examples of the filler as component (C) include silica, talc, clay, aluminum hydroxide, magnesium hydroxide, calcium carbonate and titanium oxide. Of these, silica is preferred. The rubber composition of the invention preferably takes the form of a silica-loaded rubber composition.

The amount of component (C) blended is preferably 5 to 200 parts by weight, more preferably 30 to 120 parts by weight per 100 parts by weight of the diene rubber (B) when physical properties of the resulting rubber and a balance between the extent of the developed effect and economy are taken into account.

In addition to components (A) to (C), the rubber composition of the invention may have blended therein additives which are commonly blended in tire and other general rubbers, for example, carbon black, vulcanizers, crosslinkers, vulcanizing accelerators, crosslinking accelerators, oils, antioxidants, and plasticizers. The amounts of these additives are not limited as long as the benefits of the invention are not impaired.

The method for preparing the rubber composition of the invention is not particularly limited. One exemplary method is by adding (A) an organosilicon compound, (C) silica, and other components to (B) diene rubber, and kneading the components in a standard way.

### [3] Rubber Article or Tire

The rubber composition of the invention may be used in the manufacture of a rubber article, for example, tire, the rubber article comprising a cured product which is obtained by kneading components (A) to (C) and other components in a standard way and vulcanizing or crosslinking the mixture. Especially in manufacturing tires, the rubber composition is preferably used as treads.

Since the tires obtained from the rubber composition are significantly reduced in rolling resistance and significantly improved in wear resistance, the desired saving of fuel consumption is achievable.

The tire may have any prior art well-known structures and be manufactured by any prior art well-known techniques. In the case of pneumatic tires, the gas introduced therein may be ordinary air, air having a controlled oxygen partial pressure, or an inert gas such as nitrogen, argon or helium.

### EXAMPLES

Examples and Comparative Examples are given below for further illustrating the invention although the invention is not limited thereto.

All parts are by weight (pbw). The kinematic viscosity is measured at 25° C. by a Cannon-Fenske viscometer.

For GPC and ¹H-NMR, analysis was carried out by the following instruments under the following conditions.

### [GPC]

Instrument: HLC-8220 GPC (Tosoh Corp.)

Detector: RI

Solvent: tetrahydrofuran (THF)

Column: G4000HXL, G3000HXL, G2000HXL, G2000HXL (Tosoh Corp.)

Standard: polystyrene

### [¹H-NMR]

Instrument: JNM ECX-400 (JEOL Ltd.)

Frequency: 400 MHz

Solvent: chloroform-d

Scan count: 16 times

### [1] Preparation of Mixture of Organosilicon Compounds

### Example 1-1

A 2-L separable flask equipped with a stirrer, reflux condenser, dropping funnel and thermometer was charged with 539 g (1.0 mol) of bis(triethoxysilylpropyl)tetrasulfide, 3.0 g of methanesulfonic acid, and 148 g (2.0 mol) of n-butanol. Reaction was carried out at 80° C. for 5 hours while distilling off the generated ethanol. This was followed by the neutralization step of adding 10 g of Kyowaad 500 (Kyowa Chemical Industry Co., Ltd.). The subsequent vacuum distillation at 80° C. gave a yellow transparent liquid having a kinematic viscosity of 13 mm²/s.

On GPC and ¹H-NMR analysis, the organosilicon compound mixture thus obtained was a mixture having the average structural formula:

(C₂H₅O)₃₋ₐ(C₄H₉O)ₐSi—(CH₂)₃—S₄—(CH₂)₃—Si(OC₄H₉)_{b}(OC₂H₅)_{3-b}

wherein a+b=2. On GPC analysis, the peak area of organosilicon compounds wherein a+b is from 3 to 6 was 40% of the overall mixture.

### Example 1-2

A 2-L separable flask equipped with a stirrer, reflux condenser, dropping funnel and thermometer was charged with 539 g (1.0 mol) of bis(triethoxysilylpropyl)tetrasulfide, 3.0 g of methanesulfonic acid, and 204 g (2.0 mol) of n-hexanol. Reaction was carried out at 80° C. for 5 hours while distilling off the generated ethanol. This was followed by the neutralization step of adding 10 g of Kyowaad 500 (Kyowa Chemical Industry Co., Ltd.).

The subsequent vacuum distillation at 80° C. gave a yellow transparent liquid having a kinematic viscosity of 18 mm²/s.

On GPC and ¹H-NMR analysis, the organosilicon compound mixture thus obtained was a mixture having the average structural formula:

(C₂H₅O)₃₋ₐ(C₆H₁₃O)ₐSi—(CH₂)₃—S₄—(CH₂)₃—Si(OC₆H₁₃)_{b}(OC₂H₅)_{3-b}

wherein a+b=2. On GPC analysis, the peak area of organosilicon compounds wherein a+b is from 3 to 6 was 42% of the overall mixture.

### Example 1-3

A 2-L separable flask equipped with a stirrer, reflux condenser, dropping funnel and thermometer was charged with 539 g (1.0 mol) of bis(triethoxysilylpropyl)tetrasulfide, 3.0 g of methanesulfonic acid, and 260 g (2.0 mol) of n-octanol. Reaction was carried out at 80° C. for 5 hours while distilling off the generated ethanol. This was followed by the neutralization step of adding 10 g of Kyowaad 500 (Kyowa Chemical Industry Co., Ltd.). The subsequent vacuum distillation at 80° C. gave a yellow transparent liquid having a kinematic viscosity of 16 mm²/s.

On GPC and ¹H-NMR analysis, the organosilicon compound mixture thus obtained was a mixture having the average structural formula:

(C₂H₅O)₃₋ₐ(C₈H₁₇O)ₐSi—(CH₂)₃—S₄—(CH₂)₃—Si(OC₈H₁₇)(OC₂H₅)_{3-b}

wherein a+b=2. On GPC analysis, the peak area of organosilicon compounds wherein a+b is from 3 to 6 was 44% of the overall mixture.

### Example 1-4

A 2-L separable flask equipped with a stirrer, reflux condenser, dropping funnel and thermometer was charged with 539 g (1.0 mol) of bis(triethoxysilylpropyl)tetrasulfide, 3.0 g of methanesulfonic acid, and 51 g (0.5 mol) of n-hexanol. Reaction was carried out at 80° C. for 5 hours while distilling off the generated ethanol. This was followed by the neutralization step of adding 10 g of Kyowaad 500 (Kyowa Chemical Industry Co., Ltd.). The subsequent vacuum distillation at 80° C. gave a yellow transparent liquid having a kinematic viscosity of 16 mm²/s.

On GPC and ¹H-NMR analysis, the organosilicon compound mixture thus obtained was a mixture having the average structural formula:

(C₂H₅O)₃₋ₐ(C₆H₁₃O)ₐSi—(CH₂)₃—S₄—(CH₂)₃—Si(OC₆H₁₃)_{b}(OC₂H₅)_{3-b}

wherein a+b=0.5. On GPC analysis, the peak area of organosilicon compounds wherein a+b is from 3 to 6 was 3% of the overall mixture.

### Example 1-5

A 2-L separable flask equipped with a stirrer, reflux condenser, dropping funnel and thermometer was charged with 539 g (1.0 mol) of bis(triethoxysilylpropyl)tetrasulfide, 3.0 g of methanesulfonic acid, and 102 g (1.0 mol) of n-hexanol. Reaction was carried out at 80° C. for 5 hours while distilling off the generated ethanol. This was followed by the neutralization step of adding 10 g of Kyowaad 500 (Kyowa Chemical Industry Co., Ltd.). The subsequent vacuum distillation at 80° C. gave a yellow transparent liquid having a kinematic viscosity of 13 mm²/s.

On GPC and ¹H-NMR analysis, the organosilicon compound mixture thus obtained was a mixture having the average structural formula:

(C₂H₅O)₃₋ₐ(C₆H₁₃O)ₐSi—(CH₂)₃—S₄—(CH₂)₃—Si(OC₆H₁₃)_{b}(OC₂H₅)_{3-b}

wherein a+b=1. On GPC analysis, the peak area of organosilicon compounds wherein a+b is from 3 to 6 was 10% of the overall mixture.

### Example 1-6

A 2-L separable flask equipped with a stirrer, reflux condenser, dropping funnel and thermometer was charged with 539 g (1.0 mol) of bis(triethoxysilylpropyl)tetrasulfide, 3.0 g of methanesulfonic acid, and 307 g (3.0 mol) of n-hexanol. Reaction was carried out at 80° C. for 5 hours while distilling off the generated ethanol. This was followed by the neutralization step of adding 10 g of Kyowaad 500 (Kyowa Chemical Industry Co., Ltd.). The subsequent vacuum distillation at 80° C. gave a yellow transparent liquid having a kinematic viscosity of 25 mm²/s.

On GPC and ¹H-NMR analysis, the organosilicon compound mixture thus obtained was a mixture having the average structural formula:

(C₂H₅O)₃₋ₐ(C₆H₁₃O)ₐSi—(CH₂)₃—S₄—(CH₂)₃—Si(OC₆H₁₃)_{b}(OC₂H₅)_{3-b}

wherein a+b=3. On GPC analysis, the peak area of organosilicon compounds wherein a+b is from 3 to 6 was 60% of the overall mixture.

### Example 1-7

A 2-L separable flask equipped with a stirrer, reflux condenser, dropping funnel and thermometer was charged with 539 g (1.0 mol) of bis(triethoxysilylpropyl)tetrasulfide, 3.0 g of methanesulfonic acid, and 409 g (4.0 mol) of n-hexanol. Reaction was carried out at 80° C. for 5 hours while distilling off the generated ethanol. This was followed by the neutralization step of adding 10 g of Kyowaad 500 (Kyowa Chemical Industry Co., Ltd.). The subsequent vacuum distillation at 80° C. gave a yellow transparent liquid having a kinematic viscosity of 40 mm²/s.

On GPC and ¹H-NMR analysis, the organosilicon compound mixture thus obtained was a mixture having the average structural formula:

(C₂H₅O)₃₋ₐ(C₆H₁₃O)ₐSi—(CH₂)₃—S₄—(CH₂)₃—Si(OC₆H₁₃)_{b}(OC₂H₅)_{3-b}

wherein a+b=4. On GPC analysis, the peak area of organosilicon compounds wherein a+b is from 3 to 6 was 90% of the overall mixture.

### Example 1-8

A 2-L separable flask equipped with a stirrer, reflux condenser, dropping funnel and thermometer was charged with 539 g (1.0 mol) of bis(triethoxysilylpropyl)tetrasulfide, 3.0 g of methanesulfonic acid, and 511 g (5.0 mol) of n-hexanol. Reaction was carried out at 80° C. for 5 hours while distilling off the generated ethanol. This was followed by the neutralization step of adding 10 g of Kyowaad 500 (Kyowa Chemical Industry Co., Ltd.). The subsequent vacuum distillation at 80° C. gave a yellow transparent liquid having a kinematic viscosity of 50 mm²/s.

On GPC and ¹H-NMR analysis, the organosilicon compound mixture thus obtained was a mixture having the average structural formula:

(C₂H₅O)₃₋ₐ(C₆H₁₃O)ₐSi—(CH₂)₃—S₄—(CH₂)₃—Si(OC₆H₁₃),(OC₂H₅)_{3-b}

wherein a+b=5. On GPC analysis, the peak area of organosilicon compounds wherein a+b is from 3 to 6 was 97% of the overall mixture.

### Comparative Example 1-1

A 2-L separable flask equipped with a stirrer, reflux condenser, dropping funnel and thermometer was charged with 539 g (1.0 mol) of bis(triethoxysilylpropyl)tetrasulfide, 3.0 g of methanesulfonic acid, and 120 g (2.0 mol) of n-propanol. Reaction was carried out at 80° C. for 5 hours while distilling off the generated ethanol. This was followed by the neutralization step of adding 10 g of Kyowaad 500 (Kyowa Chemical Industry Co., Ltd.). The subsequent vacuum distillation at 80° C. gave a yellow transparent liquid having a kinematic viscosity of 13 mm²/s.

On GPC and ¹H-NMR analysis, the organosilicon compound mixture thus obtained was a mixture having the average structural formula:

(C₂H₅O)₃₋ₐ(C₃H₇O)ₐSi—(CH₂)₃—S₄—(CH₂)₃—Si(OC₃H₇)_{b}(OC₂H₅)_{3-b}

wherein a+b=2. On GPC analysis, the peak area of organosilicon compounds wherein a+b is from 3 to 6 was 40% of the overall mixture.

### Comparative Example 1-2

A 2-L separable flask equipped with a stirrer, reflux condenser, dropping funnel and thermometer was charged with 539 g (1.0 mol) of bis(triethoxysilylpropyl)tetrasulfide, 3.0 g of methanesulfonic acid, and 317 g (2.0 mol) of n-decanol. Reaction was carried out at 80° C. for 5 hours while distilling off the generated ethanol. This was followed by the neutralization step of adding 10 g of Kyowaad 500 (Kyowa Chemical Industry Co., Ltd.). The subsequent vacuum distillation at 80° C. gave a yellow transparent liquid having a kinematic viscosity of 23 mm²/s.

On GPC and ¹H-NMR analysis, the organosilicon compound mixture thus obtained was a mixture having the average structural formula:

(C₂H₅O)₃₋ₐ(C₁₀H₂₁O)ₐSi—(CH₂)₃—S₄—(CH₂)₃—Si(OC₁₀H₂₁)_{b}(OC₂H₅)_{3-b}

wherein a+b=2. On GPC analysis, the peak area of organosilicon compounds wherein a+b is from 3 to 6 was 45% of the overall mixture.

### [2] Preparation of Rubber Compositions

### Examples 2-1 to 2-7, Comparative Examples 2-1 to 2-3, and Reference Examples 2-1, 2-2

Rubber compositions were prepared by kneading the amounts shown in Tables 1 and 2 of the components shown below and the organosilicon compound mixtures in Examples and Comparative Examples in the following manner.

First, SBR and BR were kneaded on a 4-L internal mixer (MIXTRON by Kobelco) for 30 seconds.

Next, oil, carbon black, silica, the organosilicon compound mixtures of Examples and Comparative Examples or sulfide silane, stearic acid, antioxidant, and wax were added to the mix. The internal temperature was raised to 150° C., after which the mix was held at 150° C. for 2 minutes and discharged. This was followed by stretching on a roll mill. The resulting rubber was kneaded again on the internal mixer until the internal temperature reached 140° C., discharged, and stretched on a roll mill. Rubber compositions were obtained by adding zinc oxide, vulcanization accelerator and sulfur to the rubber and kneading them.

### SBR: SLR-4602 (Trinseo S.A.)

### BR: BR-01 (JSR Corp.)

### Oil: AC-12 (Idemitsu Kosan Co., Ltd.)

Carbon black: Seast 3 (Tokai Carbon Co., Ltd.)

### Silica: Nipsil AQ (Tosoh Silica Co., Ltd.)

Sulfide silane A: KBE-846 (Shin-Etsu Chemical Co., Ltd.)
Stearic acid: industrial stearic acid (Kao Corp.)

### Antioxidant: Nocrac 6C (Ouchi Shinko Chemical Industry Co., Ltd.)

### Wax: Ozoace 0355 (Nippon Seiro Co., Ltd.)

Zinc oxide: Zinc white #3 (Mitsui Mining & Smelting Co.. Ltd.)
Vulcanization accelerator (a): Nocceler D (Ouchi Shinko Chemical Industry Co., Ltd.)
Vulcanization accelerator (b): Nocceler DM-P (Ouchi Shinko Chemical Industry Co., Ltd.)
Vulcanization accelerator (c): Nocceler CZ-G (Ouchi Shinko Chemical Industry Co., Ltd.)
Sulfur: 5% oil-treated sulfur (Hosoi Chemical Industry Co., Ltd.)

The rubber compositions of Examples 2-1 to 2-7, Comparative Examples 2-1 to 2-3, and Reference Examples 2-1, 2-2 were measured for unvulcanized and vulcanized physical properties by the following methods. The results are also shown in Tables 1 and 2. The rubber compositions were press molded at 150° C. for 15 to 40 minutes into vulcanized rubber sheets (2 mm thick), which were measured for the vulcanized physical properties.

### [Unvulcanized Physical Properties]

### (1) Mooney Viscosity

According to JIS K 6300, measurement was made under conditions: temperature 100° C., preheating 1 minute, and measurement 4 minutes. The measurement result was expressed as an index based on 100 for Comparative Example 2-3. A lower index corresponds to a lower Mooney viscosity and indicates better workability.

### [Vulcanized Physical Properties]

### (2) Tensile Test

Tensile stress measurement was made according to JIS K 6251:2010. A tensile stress at 300% elongation was expressed as an index based on 100 for Comparative Example 2-3. A higher index indicates better tensile property.

### (3) Dynamic Viscoelasticity (Strain Dispersion)

Using a viscoelasticity meter (Metravib), a storage elasticity at strain 0.5%, E′ (0.5%) and a storage elasticity at strain 3.0%, E′ (3.0%) were measured under conditions: temperature 25° C. and frequency 55 Hz. A value of [E′(0.5%)−E′ (3.0%)] was computed. The test specimen was a sheet of 0.2 cm thick and 0.5 cm wide, the clamp span was 2 cm, and the initial load was 1 N.

The value of [E′ (0.5%)−E′ (3.0%)] was expressed as an index based on 100 for Comparative Example 2-3. A lower index indicates better dispersion of silica.

### (4) Dynamic Viscoelasticity (Temperature Dispersion)

Using a viscoelasticity meter (Metravib), measurement was made under conditions: tensile dynamic strain 1% and frequency 55 Hz. The test specimen was a sheet of 0.2 cm thick and 0.5 cm wide, the clamp span was 2 cm, and the initial load was 1 N.

The values of tan δ (0° C.) and tan δ (60° C.) were expressed as an index based on 100 for Comparative Example 2-3. A greater index indicates a better wet grip. A lower index indicates better rolling resistance.

### (5) Wear Resistance

Using a FPS tester (Ueshima Seisakusho Co., Ltd.), the test was carried out under conditions: sample speed 200 m/min, load 20 N, road temperature 30° C., and slip rate 5%.

The measurement result was expressed as an index based on 100 for Comparative Example 2-3. A greater index indicates a smaller abrasion and hence, better wear resistance.

TABLE 1

| | | Example | | | | | |
|---|---|---|---|---|---|---|---|
| Formulation (pbw) | | 2-1 | 2-2 | 2-3 | 2-5 | 2-6 | 2-7 |
| (B) SBR | | 80 | 80 | 80 | 80 | 80 | 80 |
| (B) BR | | 20 | 20 | 20 | 20 | 20 | 20 |
| Oil | | 30 | 30 | 30 | 30 | 30 | 30 |
| Carbon black | | 5 | 5 | 5 | 5 | 5 | 5 |
| (C) Silica | | 75 | 75 | 75 | 75 | 75 | 75 |
| (A) | Example 1-1 | 7 | — | — | — | — | — |
| Organosilicon | Example 1-2 | — | 7 | — | — | — | — |
| compound | Example 1-3 | — | — | 7 | — | — | — |
| mixture | Example 1-5 | — | — | — | 7 | — | — |
| | Example 1-6 | — | — | — | — | 7 | — |
| | Example 1-7 | — | — | — | — | — | 7 |

| | | | | | | |
|---|---|---|---|---|---|---|
| Stearic acid | 2 | 2 | 2 | 2 | 2 | 7 |
| Antioxidant | 2 | 7 | 7 | 2 | 2 | 2 |
| Wax | 1 | 1 | 1 | 1 | 1 | 1 |
| Zinc oxide | 2.5 | 2.5 | 2.5 | 2.5 | 2.5 | 2.5 |
| Vulcanization accelerator (a) | 1 | 1 | 1 | 1 | 1 | 1 |
| Vulcanization accelerator (b) | 0.3 | 0.3 | 0.3 | 0.3 | 0.3 | 0.3 |
| Vulcanization accelerator (c) | 1.5 | 1.5 | 1.5 | 1.5 | 1.5 | 1.5 |
| Sulfur | 2 | 2 | 2 | 2 | 2 | 2 |

[Unvulcanized physical properties]

| | | | | | | |
|---|---|---|---|---|---|---|
| Mooney viscosity | 97 | 95 | 93 | 95 | 93 | 95 |

[Vulcanized physical properties]

| | | | | | | |
|---|---|---|---|---|---|---|
| Tensile property M300 | 100 | 100 | 100 | 100 | 99 | 96 |
| Strain dispersion | 90 | 80 | 80 | 85 | 80 | 85 |
| [E′ (0.5%)-E′ (3.0%)] | | | | | | |
| Dynamic viscoelasticity | 106 | 110 | 113 | 110 | 110 | 106 |
| tanδ (0° C.) | | | | | | |
| Dynamic viscoelasticity | 90 | 85 | 85 | 89 | 85 | 90 |
| tanδ (60° C.) | | | | | | |
| Wear resistance | 101 | 102 | 102 | 102 | 101 | 100 |

TABLE 2

| | | Reference | | | | |
|---|---|---|---|---|---|---|
| | | Example | | Comparative Example | | |
| Formulation (pbw) | | 2-1 | 2-2 | 2-1 | 2-2 | 2-3 |
| (B) SBR | | 80 | 80 | 80 | 80 | 80 |
| (B) BR | | 20 | 20 | 20 | 20 | 20 |
| Oil | | 30 | 30 | 30 | 30 | 30 |
| Carbon black | | 5 | 5 | 5 | 5 | 5 |
| (C) Silica | | 75 | 75 | 75 | 75 | 75 |
| (A) | Example 1-4 | 7 | — | — | — | — |
| Organosilicon | Example 1-8 | — | 7 | — | — | — |
| compound | Comparative | — | — | 7 | — | — |
| mixture | Example 1-1 | | | | | |
| | Comparative | — | — | — | 7 | — |
| | Example 1-2 | | | | | |

| | | | | | |
|---|---|---|---|---|---|
| Sulfide silane A | — | — | — | — | 7 |
| Stearic acid | 2 | 2 | 2 | 2 | 2 |
| Antioxidant | 2 | 2 | 2 | 2 | 2 |
| Wax | 1 | 1 | 1 | 1 | 1 |
| Zinc oxide | 2.5 | 2.5 | 2.5 | 2.5 | 2.5 |
| Vulcanization accelerator (a) | 1 | 1 | 1 | 1 | 1 |
| Vulcanization accelerator (b) | 0.3 | 0.3 | 0.3 | 0.3 | 0.3 |
| Vulcanization accelerator (c) | 1.5 | 1.5 | 1.5 | 1.5 | 1.5 |
| Sulfur | 2 | 2 | 2 | 2 | 2 |

[Unvulcanized physical properties]

| | | | | | |
|---|---|---|---|---|---|
| Mooney viscosity | 100 | 96 | 98 | 98 | 100 |

[Vulcanized physical properties]

| | | | | | |
|---|---|---|---|---|---|
| Tensile property M300 | 100 | 80 | 99 | 90 | 100 |
| Strain dispersion | 97 | 90 | 100 | 95 | 100 |
| [E′ (0.5%)-E′ (3.0%)] | | | | | |
| Dynamic viscoelasticity | 101 | 100 | 101 | 102 | 100 |
| tanδ (0° C.) | | | | | |
| Dynamic viscoelasticity | 99 | 98 | 100 | 97 | 100 |
| tanδ (60° C.) | | | | | |
| Wear resistance | 100 | 98 | 100 | 90 | 100 |

As shown in Tables 1 and 2, the rubber compositions of Examples 2-1 to 2-7 have better unvulcanized and vulcanized physical properties than the rubber compositions which are devoid of the organosilicon compound mixture within the scope of the invention.

This indicates that tires formed from the rubber compositions containing the organosilicon compound mixture within the scope of the invention have improved silica dispersion, wear resistance, rolling resistance, and wet grip.

1. An organosilicon compound having the structural formula (1):
(R¹O)₃₋ₘ(R²O)ₘSi—(CH₂)ₕ—Sₓ—(CH₂)ᵢ—Si(OR²)ₙ(OR¹)₃₋ₙ (1)
wherein R¹ is each independently a C₁-C₃ alkyl group, R² is each independently a C₄-C₈ alkyl group, m is an integer of 0 to 3, n is an integer of 0 to 3, h is an integer of 1 to 10, i is an integer of 1 to 10, x is an integer of 2 to 8, and m+n is an integer of 3 to 6.

2. A mixture of organosilicon compounds comprising the organosilicon compound of claim 1, the organosilicon compounds having the average structural formula (2), wherein on analysis by gel permeation chromatography, the area percent of the organosilicon compound having formula (1) is 5 to 95% based on the overall mixture,
(R¹O)₃₋ₚ(R²O)ₚSi—(CH₂)ⱼ—S_{y}—(CH₂)ₖ—Si(OR²)_{q}(OR¹)_{3-q} (2)
wherein R¹ is each independently C₁-C₃ alkyl group, R² is each independently a C₄-C₈ alkyl group, p is a number of 0 to 3, q is a number of 0 to 3, j is a number of 1 to 10, k is a number of 1 to 10, y is a number of 2 to 8, and p+q is a number of 0.15 to 6.

3. A method of preparing a mixture of organosilicon compounds comprising the step of reacting at least one organosilicon compound having the structural formula (3):
(R¹O)₃Si—(CH₂)ₕ—Sₓ—(CH₂)ᵢ—Si(OR¹)₃ (3)
wherein R¹ is each independently a C₁-C₃ alkyl group, h is an integer of 1 to 10, i is an integer of 1 to 10, and x is an integer of 2 to 8, with at least one alcohol having the structural formula (4):
R²OH (4)
wherein R² is a C₄-C₈ alkyl group in the presence of a catalyst,
the mixture consisting of organosilicon compounds having the average structural formula (2):
(R¹O)₃₋ₚ(R²O)ₚSi—(CH₂)ⱼ—S_{y}—(CH₂)ₖ—Si(OR²)_{q}(OR¹)_{3-q} (2)
wherein R¹ and R² are as defined above, p is a number of 0 to 3, q is a number of 0 to 3, j is a number of 1 to 10, k is a number of 1 to 10, y is a number of 2 to 8, and p+q is a number of 0.15 to 6.

4. The method of claim 3 wherein the catalyst is methanesulfonic acid.

5. A rubber composition comprising the mixture of organosilicon compounds of claim 2.

6. A tire obtained by molding the rubber composition of claim 5.

7. A cured product of the rubber composition of claim 5.

8. A tire comprising the cured product of claim 7.
